(19) United States
(12) Patent Application Publication
(10) Pub. No.: US 2015/0177947 A1
(43) Pub. Date: Jun. 25, 2015

(54) Enhanced User Interface Systems and Methods for Electronic Devices

(71) Applicant: Motorola Mobility LLC, Chicago, IL (US)

(72) Inventors: Howard H. Shen, Los Altos, CA (US); Jason Freund, Cupertino, CA (US)

(73) Assignee: Motorola Mobility LLC, Chicago, IL (US)

(21) Appl. No.: 14/230,090

(22) Filed: Mar. 31, 2014

Related U.S. Application Data
(60) Provisional application No. 61/918,979, filed on Dec. 20, 2013.

(51) Int. Cl. G06F 3/0481; G06F 3/0482

(52) U.S. Cl. CPC G06F 3/04815; G06F 3/0482

(57) ABSTRACT

An electronic device includes a display, a user interface, and one or more motion or other sensors. One or more control circuits, operable with the display and the user interface, detect an application operating on the electronic device. The application can be to receive two-dimensional user input along a display graphics window generated by the application. The control circuit(s) can then present, on the display, a three-dimensional appearance of at least a portion of the display graphics window, and receive, with the user interface, one of a three-dimensional input or a gesture input corresponding to the three-dimensional appearance of the at least a portion of the display graphics window. The control circuit(s) can then translate the three-dimensional input or gesture input to a two-dimensional input for the display graphics window recognizable by the application, and can communicate the two-dimensional input to the application.

### CROSS REFERENCE TO PRIOR APPLICATIONS

This application claims priority and benefit under 35 U.S.C. §119(e) from U.S. Provisional Application No. 61/918,979, filed Dec. 20, 2013, which is incorporated by reference for all purposes.

### BACKGROUND

1. Technical Field

This disclosure relates generally to electronic devices, and more particularly to user interfaces for electronic devices.

2. Background Art

Electronic devices, such as mobile telephones, smart phones, gaming devices, and the like, present information to users on a display. As these devices have become more sophisticated, so too have their displays and the information that can be presented on them. For example, not too long ago a mobile phone included a rudimentary light emitting diode display capable of only presenting numbers and letters configured as seven-segment characters. Today, high-resolution liquid crystal and other displays included with mobile communication devices and smart phones can be capable of presenting high-resolution video. Many of these displays are touch-sensitive displays.

At the same time, advances in electronic device design have resulting in many devices becoming smaller and smaller. Portable electronic devices that once were the size of a shoebox now fit easily in a pocket. The reduction in size of the overall device means that the displays, despite becoming more sophisticated, have gotten smaller. It is sometimes challenging, when using small user interfaces, to conveniently view information on small displays. It can also be difficult to provide touch input to a small display when that display is a touch sensitive display. It would be advantageous to have an improved user interface for devices with small displays.

### BRIEF DESCRIPTION OF THE DRAWINGS

FIG. 1 illustrates one explanatory electronic device in accordance with one or more embodiments of the disclosure.

FIG. 2 illustrates an explanatory system level diagram of an electronic device in accordance with one or more embodiments of the disclosure.

FIG. 3 illustrates a legacy application generating a display graphics window for a prior art electronic device.

FIG. 4 illustrates an explanatory system in accordance with one or more embodiments of the disclosure presenting a three-dimensional appearance of a display graphics window.

FIG. 5 illustrates a user navigating a three-dimensional appearance with an electronic device in accordance with one or more embodiments of the disclosure.

FIG. 6 illustrates delivery of two-dimensional input translated from three-dimensional input to an application in accordance with one or more embodiments.

FIG. 7 illustrates gesture input delivered to an explanatory electronic device in accordance with one or more embodiments.

FIG. 8 illustrates one explanatory method in accordance with one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting applications operating, presenting three-dimensional appearances of two-dimensional display graphics windows, and translating three-dimensional or gesture input to two-dimensional input as described below. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of rendering three-dimensional appearances of two-dimensional display graphics windows, receiving input from user navigation of the three-dimensional appearances, and translating that input to two dimensional input understandable by legacy applications as described herein. The non-processor circuits may include, but are not limited to, a radio receiver, a radio transmitter, signal drivers, clock circuits, power source circuits, and user input devices. As such, these functions may be interpreted as steps of a method to perform the rendering, navigation, input receipt, and translation noted above. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Traditional software applications for electronic devices are configured to present a two-dimensional display graphics window across a flat display. Illustrating by example, a web browser for a tablet computer is configured to render a display graphics window presenting the website for the tablet's flat, two-dimensional display. The user views the webpage in this two-dimensional display graphics window when it is presented on the display. Where the display is a touch-sensitive display, the application can be configured to receive two-dimensional user input along the display graphics window when a user touches the display. As noted above, when a device becomes small, both viewing the two-dimensional display graphics window and delivering touch input to the same can become difficult or impossible.

Embodiments of the disclosure provide a solution to this problem by providing a rich, sophisticated, and modern user interface experience. An electronic device, which is a wearable electronic device in one embodiment, is configured to provide a user with a new and interesting way to navigate large display graphics windows with a small display. In one embodiment, the electronic device includes a display, which may be touch sensitive, a user interface, and a communication circuit. One or more control circuits are operable with the display, user interface, and communication circuit.

Embodiments of the disclosure allow traditional software applications to run on the device at an application layer level. When such an application, i.e., one that generates a two-dimensional display graphics window is running on the device, the one or more control circuits can receive the display graphics window generated by the application. Then, at an operating system layer level, the one or more control circuits can render a three-dimensional appearance of the display graphics window received from the application to be presented on the display of the device. It is important to note that in one or more embodiments, the traditional software applications are not aware that their output is being rendered as a three-dimensional appearance. This is true because the one or more control circuits, at the operating system layer level, cause the transformation to the three-dimensional appearance in a process separate from the one executing the traditional software application. When input is received from the three-dimensional environment, the one or more processors perform the reverse transformation so that the traditional software application is delivered input that it understands. This is distinct from prior art applications that simply render three-dimensional output. Advantageously, legacy applications can run on the electronic device while the user is afforded a richer, more dynamic, and more interesting user interface experience. In one embodiment, only a portion of the three-dimensional appearance of the display graphics window is presented on the display at a time. However, the user can change the portion being presented by moving the electronic device along a virtual space above the three-dimensional appearance of the display graphics window.

As the user navigates the three-dimensional appearance of the display graphics window, user input can be delivered to the device. When this user input is received, in can be of a variety of different forms. For example, since the user may be navigating a three-dimensional virtual space while navigating the three-dimensional appearance of the display graphics window, in one embodiment the user input can be in the form of three-dimensional input. As the device can include gesture detectors, in another embodiment, the user input can be gesture input. Other forms of the input will be obvious to those of ordinary skill in the art having the benefit of this disclosure.

Once this input is received, the one or more processors can then translate the user input to a two-dimensional input for the display graphics window recognizable by the application. The one or more processors can then communicate the two-dimensional input to the application. Thus, the application runs normally, just as it would on a legacy device having a simple display for the display graphics window. However, to the user, a rich and powerful three-dimensional user interface experience emerges. The one or more processors of the electronic device provide a translation and/or conversion of three-dimensional input or of gesture input for the application so that the application need not change. Advantageously, the user simply runs traditional applications but received the benefit of a new, powerful interaction experience.

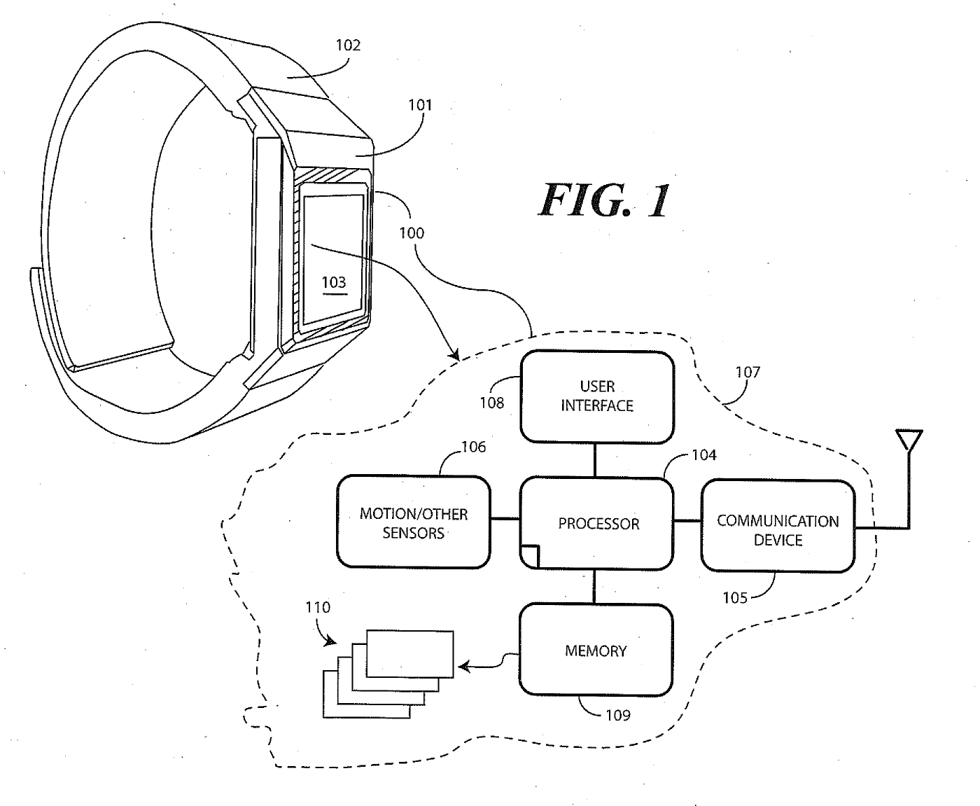

Turning now to FIG. 1, illustrated therein is one embodiment of an electronic device 100 configured in accordance with one or more embodiments of the disclosure. While there are many electronic devices suitable for use with embodiments of the invention, one particular application well suited for use with embodiments described herein is that of “wearable” devices. Such devices are described generally in commonly assigned, co-pending U.S. application Ser. No. 13/297,952, entitled, “Methods and Devices for Clothing Detection about a Wearable Electronic Device,” Dickinson, et al., inventors, filed Nov. 16, 2011, and U.S. application Ser. No. 13/297,965, entitled, “Display Device, Corresponding Systems, and Methods for Orienting Output on a Display,” Dickinson, et al., inventors, filed Nov. 16, 2011, and U.S. application Ser. No. 13/297,662, entitled “Display Device, Corresponding Systems, and Methods Therefor,” Cauwels et al., inventors, filed Nov. 16, 2011, each of which are incorporated herein by reference for all purposes. When using a wearable device, embodiments described herein contemplate that some such devices will have minimal display areas. These small displays, which can be touch-sensitive displays, may only be an inch or two inches square. The explanatory electronic device 100 of FIG. 1 is configured as a wearable device.

In FIG. 1, the electronic device includes an electronic module 101 and a strap 102 that are coupled together to form a wrist wearable device. The illustrative electronic device 100 of FIG. 1 has a touch sensitive display 103 that forms a user input operable to detect gesture input, motion input, or touch input, and a control circuit 104 operable with the touch sensitive display 103.

The electronic device 100 can be configured in a variety of ways. For example, in one embodiment the electronic device 100 includes an optional communication circuit 105, which can be wireless to form a voice or data communication device, such as a smart phone. In many embodiments, however, the electronic device 100 can be configured as a standalone device without communication capabilities. Where communication capabilities are included, in one or more embodiments other communication features can be added, including a near field communication circuit for communicating with other electronic devices. Motion and other sensors 106 can be provided for detecting gesture input when the user is not “in contact” with the touch sensitive display 103. One or more microphones can be included for detecting voice or other audible input. The electronic device 100 of FIG. 1 has an efficient, compact design with a simple user interface configured for efficient operation with one hand (which is advantageous when the electronic device 100 is worn on the wrist).

In one or more embodiments, in addition to the touch sensitive input functions offered by the touch sensitive display 103, the electronic device 100 can be equipped with additional motion and other sensors 106. In one embodiment, an accelerometer is disposed within the electronic module 101 and is operable with the control circuit 104 to detect movement. Such a motion detecto can also be used as a gesture detection device. Accordingly, when the electronic device 100 is worn on a wrist, the user can make gesture commands by moving the arm in predefined motions. Additionally, the user can deliver voice commands to the electronic device 100 via the microphones (where included).

When the touch sensitive display 103 is configured with a more conventional touch sensor, such as a capacitive sensor having transparent electrodes disposed across the surface of the touch sensitive display 103, control input can be entered with more complex gestures. For instance, in some embodiments a single swiping action across the surface of the touch sensitive display 103 can be used to scroll through lists or images being presented on the touch sensitive display 103. Accordingly, the control circuit 104 can be configured to detect these complex gestures in one or more embodiments. Further, the control circuit 104 can be configured to detect a predetermined characteristic of the gesture input. Examples of predetermined characteristics of gesture input comprise one or more of gesture duration, gesture intensity, gesture proximity, gesture accuracy, gesture contact force, or combinations thereof. Other examples will be obvious to those of ordinary skill in the art having the benefit of this disclosure.

In addition to illustrating the electronic device 100 itself, FIG. 1 also provides a schematic block diagram 107 illustrating some of the internal components of the electronic device 100. It will be clear to those of ordinary skill in the art having the benefit of this disclosure that additional components and modules can be used with the components and modules shown. The illustrated components and modules are those used for general operation in accordance with one or more embodiments of the invention. Further, the various components and modules different combinations, with some components and modules included and others omitted. The other components or modules can be included or excluded based upon need or application.

In one embodiment, the control circuit 104 is operable with the user interface 108, which may include a display, a touch-sensitive display, a touch-pad, or other input and/or output device. The control circuit 104 can also operable with one or more output devices to provide feedback to a user. The control circuit 104 can be operable with a memory 109. The control circuit 104, which may be any of one or more processors, one or more microprocessors, programmable logic, application specific integrated circuit device, or other similar device, is capable of executing program instructions and methods described herein. The program instructions and methods may be stored either on-board in the control circuit 104, or in the memory 109, or in other computer readable media operable with the control circuit 104.

The control circuit 104 can be configured to operate the various functions of the electronic device 100, and also to execute software or firmware applications and modules that can be stored in a computer readable medium, such as the memory 109. The control circuit 104 executes this software or firmware, in part, to provide device functionality. The memory 109 may include either or both static and dynamic memory components, may be used for storing both embedded code and user data. One suitable example for control circuit 104 is the MSM7630 processor manufactured by Qualcomm, Inc. The control circuit 104 may operate one or more operating systems, such as the Android™ mobile operating system offered by Google, Inc. In one embodiment, the memory 109 comprises an 8-gigabyte embedded multi-media card (eMMC).

The executable software code used by the control circuit 104 can be configured as one or more modules 110 that are operable with the control circuit 104. Such modules 110 can store instructions, control algorithms, and so forth. The instructions can instruct processors or control circuit 104 to perform the various steps of the methods described herein. For example, in one embodiment the one or modules 110 can include instructions enabling the control circuit 104 to generate three-dimensional renderings of display graphics windows, as well as the translation of three-dimensional input to two-dimensional input that is understandable by a legacy application in one or more embodiments.

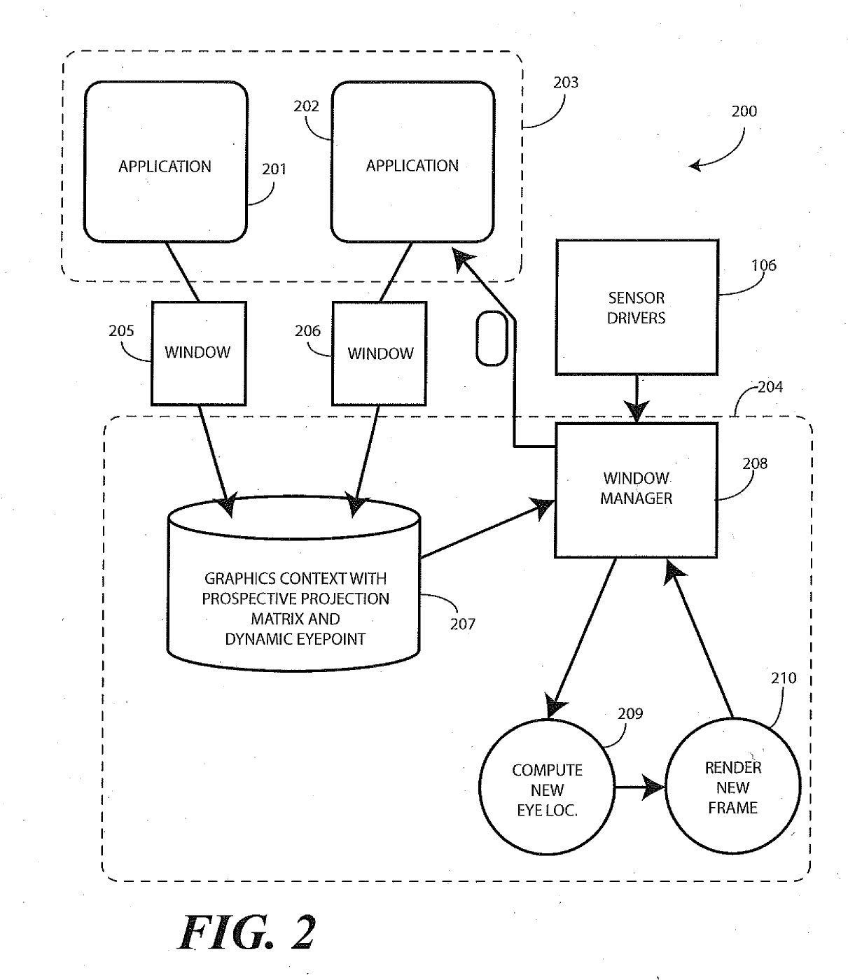

The control circuit 104 can be configured to execute a number of various functions. In one embodiment, the control circuit 104 is configured to detect an application operating on the electronic device 100. In one embodiment, the application is to receive two-dimensional user input along a display graphics window generated by the application. The control circuit 104 can then present, on the display 103, a three-dimensional appearance of at least a portion of the display graphics window. The control circuit 104 can then receive, from the user interface 108, one of a three-dimensional input or a gesture input corresponding to the three-dimensional appearance of at least the portion of the display graphics window being presented on the display 103. The control circuit 104 can then translate the three-dimensional input or the gesture input to a two-dimensional input for the display graphics window that is recognizable by the application operating on the electronic device 100. The control circuit 104 can then communicate the two-dimensional input to the application in one or more embodiments. These steps will become clearer in the discussion of FIGS. 2-7 below.

In one embodiment, the control circuit 104 is operable to detect one of three-dimensional input or gesture input. In one embodiment, the control circuit 104 is configured to detect a predetermined characteristic of a gesture input. Examples include gesture duration, gesture intensity, gesture proximity, gesture accuracy, gesture contact force, or combinations thereof. In one embodiment, where the user interface 108 comprises a touch-sensitive display, the three-dimensional input or the gesture input may be detected from contact or motions of a finger or stylus across the touch-sensitive display. In another embodiment, where the user interface 108 comprises an infrared detector, the three-dimensional input or the gesture input may be detected from reflections of infrared signals from a user while the user is making gestures in close proximity to the user interface 108. Where the user interface 108 comprises a camera, the three-dimensional input or the gesture input may be detected by capturing successive images of a user making a gesture in close proximity to the user interface 108.

In one embodiment, the user interface 108 comprises the display 103, which is configured to provide visual output, images, or other visible indicia to a user. One example of a display 103 suitable for use in a wearable device is 1.6-inch organic light emitting diode (OLED) device. As noted above, the display 103 can include a touch sensor to form touch sensitive display configured to receive user input across the surface of the display 103. Optionally, the display 103 can also be configured with a force sensor as well. Where configured with both a touch sensor and force sensor, the control circuit 104 can determine not only where the user contacts the display 103, but also how much force the user employs in contacting the display 103. Accordingly, the control circuit 104 can be configured to detect input in accordance with a detected force, direction, duration, and/or motion.

The touch sensor of the user interface 108, where included, can include a capacitive touch sensor, an infrared touch sensor, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., control circuit 104 or another display specific control circuit, to detect an object in close proximity with—or touching—the surface of the display 103, a touch-pad (not shown), or other contact area of the electronic device 100, or designated areas of the housing of the electronic device 100. The capacitive sensor performs this operation by establishing electric field lines between pairs of capacitive sensors and then detecting perturbations of those field lines. The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques. For example, commonly assigned U.S. patent application Ser. No. 11/679,228, entitled “Adaptable User Interface and Mechanism for a Portable Electronic Device,” filed Feb. 27, 2007, which is incorporated herein by reference, describes a touch sensitive display employing a capacitive sensor.

Where included, the force sensor of the user interface 108 can also take various forms. For example, in one embodiment, the force sensor comprises resistive switches or a force switch array configured to detect contact with the user interface 108. An “array” as used herein refers to a set of at least one switch. The array of resistive switches can function as a force-sensing layer, in that when contact is made with either the surface of the user interface 108, changes in impedance of any of the switches may be detected. The array of switches may be any of resistance sensing switches, membrane switches, force-sensing switches such as piezoelectric switches, or other equivalent types of technology. In another embodiment, the force sensor can be capacitive. One example of a capacitive force sensor is described in commonly assigned, U.S. patent application Ser. No. 12/181,923, filed Jul. 29, 2008, published as US Published Patent Application No. US-2010-0024573-A1, which is incorporated herein by reference.

In yet another embodiment, piezoelectric sensors can be configured to sense force upon the user interface 108 as well. For example, where coupled with the lens of the display, the piezoelectric sensors can be configured to detect an amount of displacement of the lens to determine force. The piezoelectric sensors can also be configured to determine force of contact against the housing of the electronic device rather than the display or other object.

In one embodiment, the user interface 108 includes one or more microphones to receive voice input, voice commands, and other audio input. In one embodiment, a single microphone can be used. Optionally, two or more microphones can be included to detect directions from which voice input is being received. For example a first microphone can be located on a first side of the electronic device for receiving audio input from a first direction. Similarly, a second microphone can be placed on a second side of the electronic device for receiving audio input from a second direction. The control circuit 104 can then select between the first microphone and the second microphone to detect user input.

In yet another embodiment, three-dimensional input and/or gesture input is detected by light. The user interface 108 can include a light sensor configured to detect changes in optical intensity, color, light, or shadow in the near vicinity of the user interface 108. The light sensor can be configured as a camera or image-sensing device that captures successive images about the device and compares luminous intensity, color, or other spatial variations between images to detect motion or the presence of an object near the user interface. Such sensors can be useful in detecting gesture input when the user is not touching the overall device. In another embodiment, an infrared sensor can be used in conjunction with, or in place of, the light sensor. The infrared sensor can be configured to operate in a similar manner, but on the basis of infrared radiation rather than visible light. The light sensor and/or infrared sensor can be used to detect gesture commands.

Motion or other sensors 106 can also be included to detect gesture or three-dimensional input. In one embodiment, an accelerometer can be included to detect motion of the electronic device. The accelerometer can also be used to determine the spatial orientation of the electronic device in three-dimensional space by detecting a gravitational direction. In addition to, or instead of, the accelerometer, an electronic compass can be included to detect the spatial orientation of the electronic device relative to the earth's magnetic field. Similarly, the motion or other sensors 106 can include one or more gyroscopes to detect rotational motion of the electronic device. The gyroscope can be used to determine the spatial rotation of the electronic device in three-dimensional space. Each of the motion or other sensors 106 can be used to detect gesture input.

The user interface 108 can include output devices as well. For example, in one embodiment the user interface 108 comprises an audio output to provide aural feedback to the user. For example, one or more loudspeakers can be included to deliver sounds and tones when gesture or three-dimensional input is detected. Alternatively, when a cover layer of a display 103 or other user interaction surface is coupled to piezoelectric transducers, the cover layer can be used as an audio output device as well.

A motion generation device can be included in the user interface 108 for providing haptic feedback to a user. For example, a piezoelectric transducer or other electromechanical device can be configured to impart a force upon the user interface 108 or a housing of the electronic device 100 to provide a thump, bump, vibration, or other physical sensation to the user. Of course, where included, the output device, the audio output, and motion generation device can be used in any combination.

In one or more embodiments, the electronic module 101 can be detachable from the strap 102. For example, where the electronic device 100 is configured as a wristwatch, the electronic module 101 can be selectively detached from the strap 102 in some embodiments so as to be used as a stand alone electronic device by itself. In one or more embodiments, the electronic module 101 can be detached from the strap 102 so that it can be coupled with, or can communicate or interface with, other devices. For example, where the electronic module 101 includes a communication circuit 105 with wide area network communication capabilities, such as cellular communication capabilities, the electronic module 101 may be coupled to a folio or docking device to interface with a tablet-style computer. In this configuration, the electronic module 101 can be configured to function as a modem or communication device for the tablet-style computer. In such an application, a user may leverage the large screen of the tablet-style computer with the computing functionality of the electronic module 101, thereby creating device-to-device experiences for telephony, messaging, or other applications. The detachable nature of the electronic module 101 serves to expand the number of experience horizons for the user.

Any of the electronic module 101, the strap 102, or both can include control circuits, power sources, microphones, communication circuits, and other components. The power sources can comprise rechargeable cells, such as lithium-ion or lithium polymer cells. Other electrical components, including conductors or connectors, safety circuits, or charging circuits used or required to deliver energy to and from the cell, may be included as well. In one embodiment, the rechargeable cell can be a 400 mAh lithium cells.

Now that explanatory hardware components have been described, turning to FIG. 2, illustrated therein is a system level view of one explanatory electronic device (100) configured in accordance with one or more embodiments of the disclosure. One or more applications 201,202 can operate on the electronic device (100). In one embodiment, the one or more applications 201,202 operate at an application layer level 203. Other components of the system 200 operate an operating system layer level 204 in one or more embodiments.

The applications 201,202 can be any of a variety of applications. Examples of some applications 201,202 that can be operable in the application layer level 203 include an e-mail application, a calendar application, a web browser application, a cellular call processing stack, user interface services software, a language pack, and so forth. Other software applications will be obvious to those of ordinary skill in the art having the benefit of this disclosure.

Each application 201,202 generates a corresponding display graphics window 205,206. In one embodiment, the display graphics windows 205,206 are two-dimensional windows configured to be operable either with a pointer device, such as a cursor or mouse, or with a touch-sensitive display in that they are to receive two-dimensional user input along each display graphics window 205,206. Illustrating by example, where an application 201 is a web browser, the corresponding display graphics window 205 may be a web page configured for presentation on a two-dimensional touch sensitive display. The web page may include various links and active objects. When a user touches the touch sensitive display atop a link, for example, this constitutes two-dimensional input in that it corresponds to Cartesian coordinates along the display graphics window 205 that alert the application 201 which link has been actuated.

One or more processors of the electronic device (100) receive this display graphics window 205 and render a three-dimensional appearance of the display graphics window 205 in one or more embodiments. Information from the display graphics window 205 can be parsed in a data store 207 to determine contextual information about the display graphics window 205. A window manager 208 then generates from this contextual information a three-dimensional appearance for the display graphics window 205 that, when viewed through a display of an electronic device (100), appears as a viewport into a three-dimensional scene composed of windows displaying three-dimensional renderings of the two-dimensional display graphics window 205. While this occurs, the application 201 has no knowledge that the display graphics window 205 is being rendered in a three-dimensional representation.

In one embodiment, the generation of the three-dimensional appearance occurs at an operating system layer level 204. For example, in one embodiment the operating system layer level 204 comprises an Andriod.sup™ operating system equipped with a three-dimensional scene-graphing engine for composing windows. The operating system layer level 204 can also include the Android SufaceFlinger.sup™ engine that possesses one “texture,” e.g., a bitmap applied to geometry in a scene, for each window the window manager 208 has running in the system 200. Using these tools, the window manager can render its windows as a three-dimensional representation with an orthographic projection and viewport that aligns all visible windows with the boundary of the display.

In one embodiment, the window manager 208 is configured to render windows in a three-dimensional environment. In one embodiment, the window manager 208 does not restrict the viewport offered by the display (103) of the electronic device (100) to a scale that maps one pixel from the display graphics window 205 received from the application 201 to one pixel as seen on the display (103) of the electronic device (100). In on embodiment, the window manager 208 does not restrict the eye location and view direction seen by the user through the display (103) of the electronic device (100) to be aligned within the boundaries of the display (103). In one embodiment, the window manager 208 is further not restricted to updating images presented on the display (103) whenever content in any visible window has updated. It may update the display (103) when new sensor information is received. In one embodiment, the graphics context rendered by the window manager 208 uses a perspective, rather than an orthogonal, projection.

After generating the three-dimensional representation, the window manager 208 then receives signals from the motion and other sensors 106 to control the portion of the three-dimensional representation being displayed. As the user moves the electronic device (100) to three-dimensionally navigate the three-dimensional rendering, the window manager 208 receives corresponding input signals and computes 209 new locational information to render 210 new frames. This process will become clearer in the examples that follow.

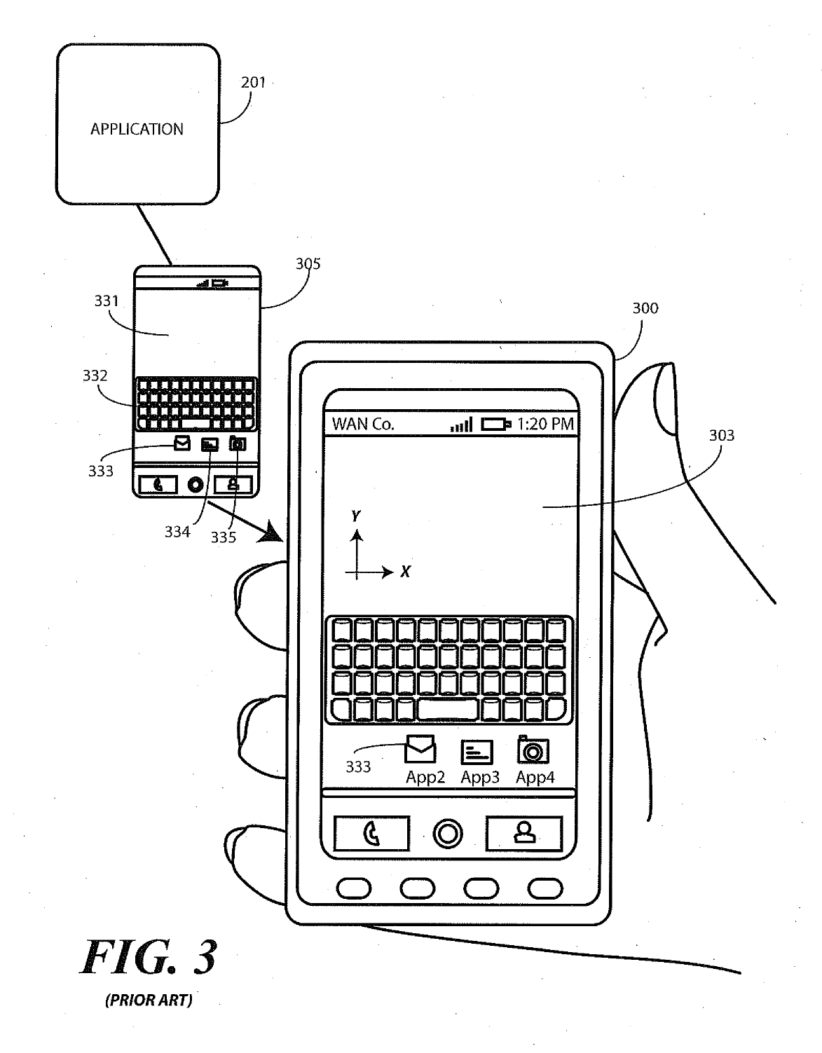

Turning now to FIG. 3, illustrated therein is a prior art electronic device 300 running a legacy application 201. In this illustration, the legacy application 201 is a word processing program. In other embodiments, the application 201 can be a dynamically updated application, such as a gaming application. The legacy application 201 generates a display graphics window 305, which includes a workspace 331, a virtual keypad 332, and one or more user actuation icons 333,334,335. Here a first user actuation icon 333 is to launch an email application, while a second user actuation icon 334 launches a web browsing application. A third user actuation icon 335 launches a camera application, and so forth. These examples are illustrative only, as others will be obvious to those of ordinary skill in the art having the benefit of this disclosure.

As shown in FIG. 3, the display graphics window 305 gets presented on the display 303 of the electronic device 300. The display 303 is a flat, two-dimensional surface. The application 201 is configured to receive two-dimensional input in the form of Cartesian (X,Y) coordinates relative to the display 303. Thus, if a user touches user actuation icon 333 to launch the email application, this user input is delivered to the application 201 as an x-coordinate and a y-coordinate along the display graphics window 305.

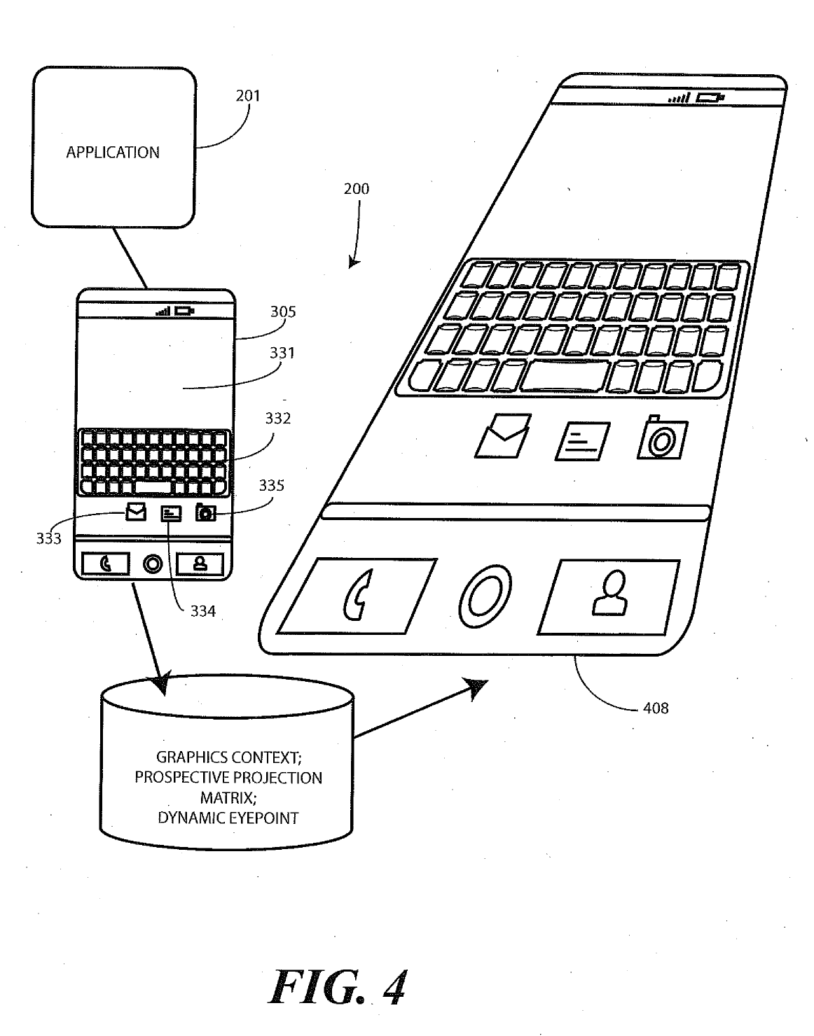

Turning now to FIG. 4, illustrated therein is the system 200 of FIG. 2 in action. As with FIG. 3, the application 201 generates the two-dimensional display graphics window 305. In one embodiment, the display graphics window 305 comprises a dynamic display graphics window, as would be the case in a gaming application where the display graphics window 305 changes rapidly as a function of time. The display graphics window 305 still includes the workspace 331, the virtual keypad 332, and one or more user actuation icons 333,334,335.

The window manager (208) then generates a three-dimensional appearance 408 of the display graphics window 305. The application 201 functions just as if it were running on a prior art electronic device (300) with the display graphics window 305 being presented on a flat, two-dimensional display (303). However, due to the action of the window manager (208), the user is seeing the three-dimensional appearance 408 instead. When the application 201 receives input, it expects the input to be of the Cartesian form described above. To accommodate this, in one embodiment the window manager translates any three-dimensional or gesture input to two-dimensional input for the display graphics window 305 so that it will be recognizable by the application 201.

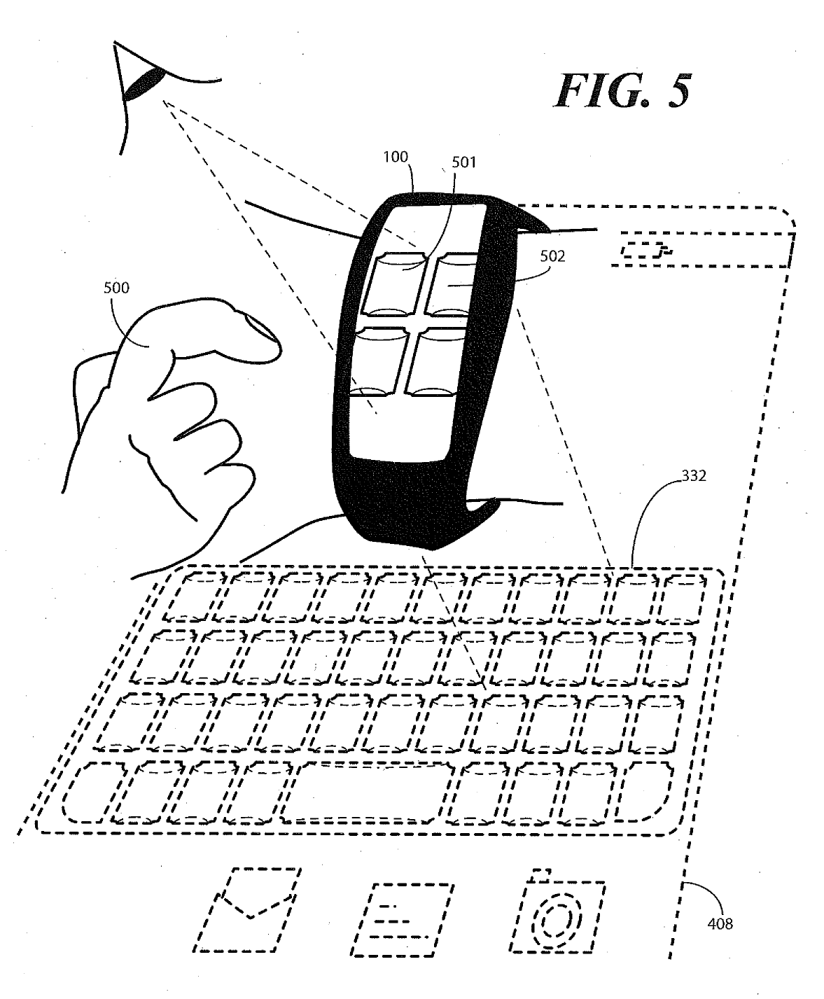

Turning now to FIG. 5, a user 500 is using the electronic device 100 of FIG. 1 to three-dimensionally navigate the three-dimensional appearance 408 of the display graphics window (305). The display 103 of the electronic device 100, being small, serves as a viewport into the three-dimensional representation 408 of the display graphics window (305). The user 500 can move the electronic device 100 around along the three-dimensional representation 408 of the display graphics window (305) to navigate the three-dimensional representation 408 of the display graphics window (305). The window manager (208) continually updates the view seen through the viewport of the display 103 in response to input signals from the motion or other sensors (106). The system allows the user 500 to navigate large three-dimensional representation 408 of the display graphics window (305) with a very small display. Movement of the electronic device 100 allows the user 500 to select which view of the three-dimensional representation 408 of the display graphics window (305) they see. In one embodiment, three-dimensional or gesture input can be received by the electronic device 100, with this three-dimensional or gesture input being mapped along the three-dimensional representation 408 of the display graphics window (305).

As shown in FIG. 5, the three-dimensional representation 408 of the display graphics window (305) has been rendered in virtual space. The display 103 of the electronic device 100 serves as a window into the space. The window manager (208) presents, on the display, a portion of the virtual space that is a function of the three-space location of the electronic device 100 within the virtual space. In FIG. 5, the user 500 is viewing some of the keys 501,502 of the virtual keypad 332. As the device is moved, the user's viewpoint changes. Thus, the window manager (208) alters the graphics presented on the display 103 as a function of this changing viewpoint.

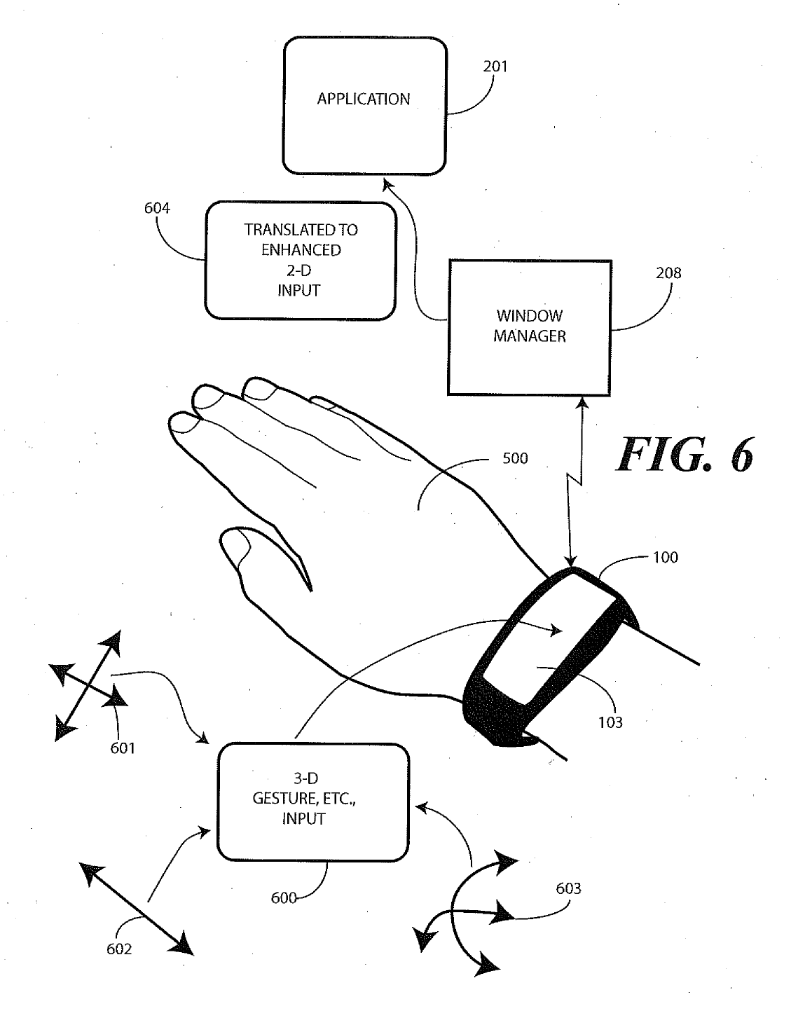

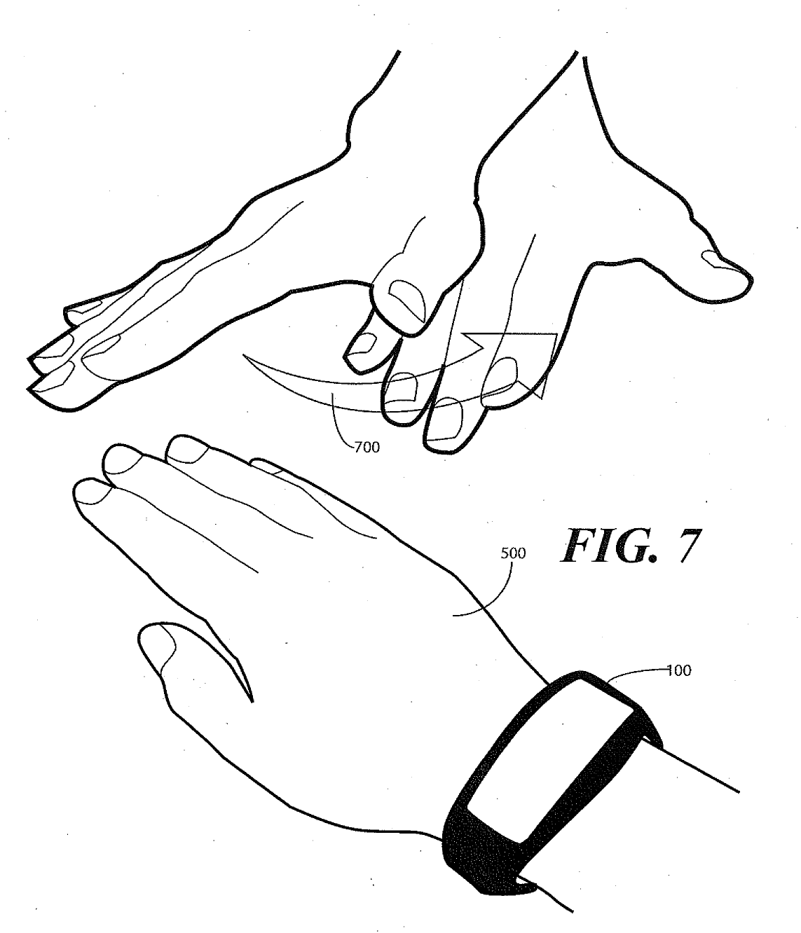

Turning now to FIGS. 6 and 7, illustrated therein are the receipt of three-dimensional and gesture input, respectively. Beginning with FIG. 6, three-dimensional input 600 can be delivered to the electronic device 100 while the user 500 navigates the three-dimensional representation (408) of the display graphics window (305). Examples of three-dimensional input 600 include panning 601, zooming 602, and rotation 603. Other examples will be obvious to those of ordinary skill in the art having the benefit of this disclosure.

The user 500 can execute panning 601 by moving the electronic device 100 along the three-dimensional representation (408) of the display graphics window (305). The user 500 can execute zooming 602 by moving the electronic device 100 closer to, or farther from, the three-dimensional representation (408) of the display graphics window (305). The user 500 can execute rotation 603 by altering the angle of a plane defined by the three-dimensional representation (408) of the display graphics window (305) and the electronic device 100.

When the three-dimensional input 600 is received, in one embodiment the window manager 208 translates this three-dimensional input 600 into a two-dimensional input 604 for the display graphics window (305) that is recognizable by the application 201. In one embodiment, this translation is simple. For example, if the user 500 touches the display 103 while looking at one of the user actuation icons (333,334,335), the window manager 208 may simply provide the Cartesian coordinate of the selected icon to the application 201.

However, by having the advantage of three-dimensional input 600, a richer user experience can be obtained. For example, in one embodiment, the translation of the three-dimensional input 600 to two-dimensional input 604 comprises translating the three-dimensional input 600 into Cartesian coordinates corresponding to the display graphics window (305) and at least one other input characteristic. Illustrating by example, if the user 500 selects a user actuation icon (333) when the electronic device 100 is “zoomed in” on that user actuation icon (333), this can be translated into a different two-dimensional input 604 than when the user 500 selects the user actuation icon (333) when the electronic device 100 is “zoomed out,” i.e., when the user 500 has moved the electronic device 100 away from the three-dimensional representation (408) of the display graphics window (305). For instance, the former may be translated to an X-Y coordinate with a longer duration, harder force, faster velocity, or higher pressure, while the latter may be translated to the same X-Y coordinate but with a shorter duration, softer force, slower velocity, or lower pressure. If the application 201 associates different operations to a short duration touch at an X-Y coordinate than it does to a long duration touch at the same X-Y coordinate, the user 500 is provided with a three-dimensional, interactive user interface experience that is far more interesting than touching a flat piece of glass.

Thus, in one or more embodiments, the translated two-dimensional input 604 comprises Cartesian coordinates corresponding to the three-dimensional representation (408) of the display graphics window (305) and at least one other input characteristic. Examples of input characteristics include duration input, velocity input, pressure input, motion input, and so forth. Others will be obvious to those of ordinary skill in the art having the benefit of this disclosure. Correlation of the three-dimensional input 600 to the input characteristic can vary, and may be determined by the particular application 201. Thus, embodiments of the disclosure provide the designer with new degrees of freedom to create new user interface paradigms for legacy applications. This is one of the many advantages afforded by embodiments of the disclosure.

Turning now to FIG. 7, gesture input 700 can be delivered to the electronic device 100 while the user 500 navigates the three-dimensional representation (408) of the display graphics window (305). Examples of gestures include waves, flicks, touches, predefined motion of the user's arm, and so forth. Each gesture can be accompanied by a gesture characteristic. Examples include gesture duration, gesture intensity, gesture proximity, gesture accuracy, gesture contact force, or combinations thereof. For example, where the gesture input comprises a hand-waving motion, the window manager (208) translates this gesture input 700 into a two-dimensional input (604) for the display graphics window (305) that is recognizable by the application (201). If the hand waving lasts for one duration, this may correspond to a first two-dimensional input (604), while hand waving of a second duration may correspond to a second two-dimensional input (604).

In one embodiment, the user 500 can tap the electronic device 100 to deliver gesture input. In another embodiment, the user 500 can make a sliding gesture along the electronic device 100 to deliver gesture input. In FIG. 7, the user 500 is making a hand-waving gesture to deliver the gesture input 700. Other examples of gesture inputs will be obvious to those of ordinary skill in the art having the benefit of this disclosure.

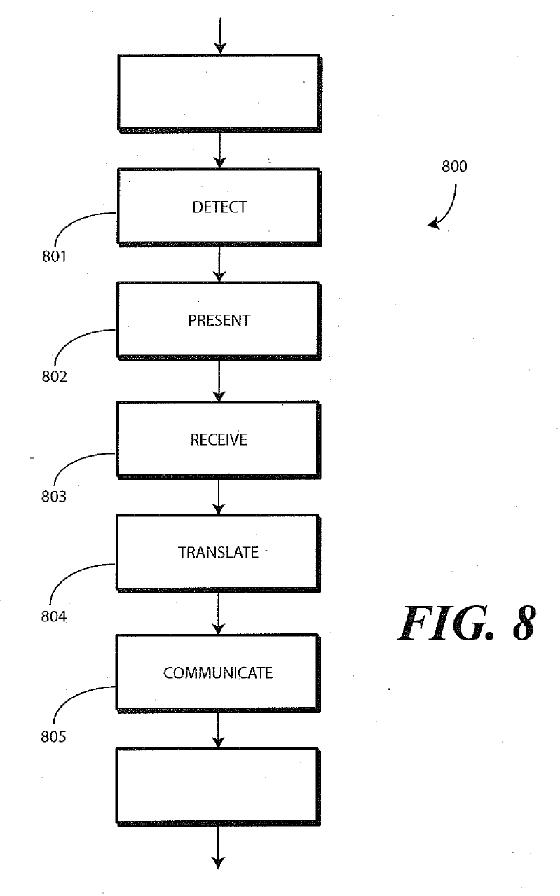

Turning now to FIG. 8, illustrated therein is one explanatory method 800 in accordance with one or more embodiments of the disclosure. Many of the method steps have been described above with reference to the apparatus and system drawings. The method steps are set forth in FIG. 8 in flow chart form and are suitable for coding as executable code for one or more processors or control circuits.

Beginning at step 801, the method 800 detects an application operating on an electronic device. In one embodiment, this step 801 is performed with one or more processors or one or more control circuits. In one embodiment, the application detected at step 801 is to receive two-dimensional user input in a display graphics window.

At step 802, the method 800 presents a three-dimensional appearance of the display graphics window. In one embodiment, step 802 presents only one or more portions of the three-dimensional appearance to function as a viewport into the three-dimensional appearance. In one embodiment, the presentation of step 802 occurs on a display of the electronic device. In one embodiment, the presentation of step 802 changes as the electronic device three-dimensionally navigates the three-dimensional appearance.

At step 803, the method 800 receives one of a three-dimensional input or a gesture input. In one embodiment, the input received at step 803 is received at a user interface of an electronic device. Examples of three-dimensional input include one of a panning input, a rotational input, or a zoom input. Examples of gesture input include arm motions, hand motions, body motions, head motions, and so forth.

At step 804, the method 800 translates the three-dimensional or gesture input to a two-dimensional input recognizable by the application. In one embodiment, step 804 is carried out by one or more processors or one or more control circuits of an electronic device. In one embodiment, the translation of step 804 comprises representing the three-dimensional or gesture input as Cartesian coordinates corresponding to the display graphics window and at least one other input characteristic. Examples of input characteristics include a duration input, a velocity input, a pressure input, or a motion input. At step 805, the two-dimensional output translated at step 804 is communicated to the application.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a display;
a user interface;
one or more control circuits, operable with the display and the user interface, the one or more control circuits to:
detect an application operating on the electronic device, the application to receive two-dimensional user input along a display graphics window generated by the application;
present, on the display, a three-dimensional appearance of at least a portion of the display graphics window;
receive, with the user interface, one of a three-dimensional input or a gesture input corresponding to the three-dimensional appearance of the at least the portion of the display graphics window;
translate the one of the three-dimensional input or the gesture input to a two-dimensional input for the display graphics window recognizable by the application; and
communicate the two-dimensional input to the application.

2. The electronic device of claim 1, the electronic device comprising a wearable electronic device.

3. The electronic device of claim 2, the display comprising a touch-sensitive display.

4. The electronic device of claim 1, the one or more control circuits to detect a predetermined characteristic of the gesture input, wherein the predetermined characteristic comprises one or more of gesture duration, gesture intensity, gesture proximity, gesture accuracy, gesture contact force, or combinations thereof.

5. The electronic device of claim 1, the two-dimensional input comprising Cartesian coordinates corresponding to the display graphics window and at least one other input characteristic.

6. The electronic device of claim 5, the at least one other input characteristic comprising one or more of a duration input, a velocity input, a pressure input, or a motion input.

7. The electronic device of claim 1, the three-dimensional input comprising one of a panning input, a rotational input, or a zoom input.

8. The electronic device of claim 1, the display graphics window comprising a dynamic display graphics window.

9. The electronic device of claim 8, content of the dynamic display graphics window changing as a function of time.

10. The electronic device of claim 1, the application comprising a dynamically updated application.

11. The electronic device of claim 1, the one or more control circuits to operate the application at an application layer level, and to present the three-dimensional appearance of the display graphics window at an operating system layer level.

12. A method, comprising:
detecting, with one or more processors, an application operating on an electronic device, the application to receive two-dimensional user input in a display graphics window;
presenting, on a display of the electronic device, one or more portions of a three-dimensional appearance of the display graphics window;
receiving, with a user interface of the electronic device, a three-dimensional input;
translating, with the one or more processors, the three-dimensional input to a two-dimensional input recognizable by the application; and
communicating, the two-dimensional input to the application.

13. The method of claim 12, further comprising receiving a gesture input with the user interface.

14. The method of claim 12, the translating comprising representing the three-dimensional input as Cartesian coordinates corresponding to the display graphics window and at least one other input characteristic.

15. The method of claim 14, the at least one other input characteristic comprising one or more of a duration input, a velocity input, a pressure input, or a motion input.

16. The method of claim 12, the three-dimensional input comprising one of a panning input, a rotational input, or a zoom input.

17. The method of claim 12, further comprising changing the one or more portions of the three-dimensional appearance of the display graphics window as the electronic device moves.
